(19) United States
(12) Patent Application Publication
(10) Pub. No.: US 2018/0249516 A1
(43) Pub. Date: Aug. 30, 2018

(54) OPERATION METHOD PERFORMED BY TERMINAL SUPPORTING SIDELINK IN WIRELESS COMMUNICATION SYSTEM AND TERMINAL USING THE METHOD

(71) Applicant: LG ELECTRONICS INC., Seoul (KR)

(72) Inventors: Sunghoon JUNG, Seoul (KR); Jaewook LEE, Seoul (KR)

(21) Appl. No.: 15/753,056

(22) PCT Filed: Aug. 18, 2016
(86) PCT No.: PCT/KR2016/009127

§ 371 Date: Feb. 15, 2018

Related U.S. Application Data
(60) Provisional application No. 62/206,307, filed on Aug. 18, 2015.

(51) Int. Cl. H04W 76/11; H04W 8/00; H04W 72/04

(52) U.S. Cl. CPC H04W 76/11; H04W 88/04; H04W 72/048; H04W 8/005

(57) ABSTRACT

Provided are an operation method performed by a terminal supporting sidelink in a wireless communication system, and a terminal using the method. The method is characterized by obtaining an identity (ID) of another terminal to be connected via sidelink, and reporting the obtained ID to a network.

### CROSS-REFERENCE TO RELATED APPLICATIONS

This application is the National Stage filing under 35 U.S.C. 371 of International Application No. PCT/KR2016/009127, filed on Aug. 18, 2016, which claims the benefit of U.S. Provisional Application No. 62/206,307 filed on Aug. 18, 2015, the contents of which are all hereby incorporated by reference herein in their entirety.

### BACKGROUND OF THE INVENTION

### Field of the Invention

The present invention relates to wireless communication, and more particularly, to a method performed by a user equipment supporting sidelink in a wireless communication system and a user equipment performing the method.

### Related Art

In International Telecommunication Union Radio communication sector (ITU-R), a standardization task for International Mobile Telecommunication (IMT)-Advanced, that is, the next-generation mobile communication system since the third generation, is in progress. IMT-Advanced sets its goal to support Internet Protocol (IP)-based multimedia services at a data transfer rate of 1 Gbps in the stop and slow-speed moving state and of 100 Mbps in the fast-speed moving state.

For example, 3^{rd} Generation Partnership Project (3GPP) is preparing for LTE-Advanced improved from Long Term Evolution (LTE) based on Orthogonal Frequency Division Multiple Access (OFDMA)/Single Carrier-Frequency Division Multiple Access (SC-FDMA) transmission schemes as a system standard to satisfy the requirements of IMT-Advanced. LTE-Advanced is one of strong candidates for IMT-Advanced.

There is a growing interest in a Device-to-Device (D22) technology in which devices perform direct communication. In particular, D2D has been in the spotlight as a communication technology for a public safety network. A commercial communication network is rapidly changing to LTE, but the current public safety network is basically based on the 2G technology in terms of a collision problem with existing communication standards and a cost. Such a technology gap and a need for improved services are leading to efforts to improve the public safety network.

The public safety network has higher service requirements (reliability and security) than the commercial communication network. In particular, if coverage of cellular communication is not affected or available, the public safety network also requires direct communication between devices, that is, D2D operation.

The D2D operation includes a signal transmission/reception operation between adjacent devices and may be called a ProSe (Proximity Service) operation and may have various advantages. For example, a D2D user equipment may have high data rate and low latency data communication. Further, the D2D operation may distribute traffic concentrated on the base station. When the D2D user equipment acts as a relay device, it may also serve to extend the coverage of the base station.

The D2D user equipment may operate as a user equipment that acts as a relay device to connect a sidelink and a cellular link. That is, the D2D user equipment may operate as a relay user equipment.

A relay user equipment can act as a relay device between a specific user equipment and the network. In this connection, a specific user equipment may also be referred to as a remote user equipment (remote UE).

On the other hand, the serving cell of the relay user equipment may be different from the serving cell of the remote user equipment. In this case, there may be a case where the serving cell of the relay user equipment cannot grasp the remote user equipment depending on the degree of cooperation between the serving cells. In this case, under the control of the network, it may be difficult to determine a pair between the relay user equipment and the remote user equipment.

### SUMMARY OF THE INVENTION

The present invention provides a method performed by a user equipment supporting sidelink in a wireless communication system and a user equipment performing the method.

In one aspect, provided is a method performed by a user equipment supporting a sidelink in a wireless communication system including a network. The method includes acquiring an identity (ID) of another user equipment to be connected thereto using the sidelink and reporting the acquired ID to the network.

The user equipment may be configured to provide a relay service between the another user equipment and the network.

The user equipment may receive a sidelink communication request message from the another user equipment and the sidelink communication request message may include the ID of the another user equipment.

Reporting the acquired ID to the network may comprise reporting the acquired ID to the network using sidelink user equipment (UE) information (SidelinkUEInformation) of the user equipment.

The sidelink user equipment (UE) information may further include an ID of the user equipment.

The method may further include receiving a device-to-device (D2D) configuration from the network. The D2D configuration may indicate at least one of a transmission resource used by the user equipment to transmit a sidelink signal to the another user equipment and a reception resource used to receive the sidelink signal from the another user equipment.

The acquired ID may be configured to allow the network to identify the another user equipment in a sidelink operation.

The user equipment may be connected to the another user equipment in a 1:1 manner under the control of the network.

The another user equipment may be in a radio resource control (RRC) idle state.

In another aspect, provided is a user equipment supporting a sidelink in a wireless communication system. The user equipment includes a RF (radio frequency) unit configured to receive or transmit a RF signal and a processor operatively coupled to the RF unit. The processor is configured for: acquiring an identity (ID) of another user equipment to be connected thereto using the sidelink and controlling the RF unit to report the acquired ID to the network.

Even when the relay user equipment and the remote user equipment have different serving cells, the network may identify the remote user equipment since, for example, the relay user equipment provides the ID of the remote user equipment to the network using the sidelink UE information. Thus, the network can determine/control the pair between the relay user equipment and the remote user equipment.

### BRIEF DESCRIPTION OF THE DRAWINGS

FIG. 1 shows a wireless communication system to which the present invention is applied.

FIG. 2 is a diagram showing a wireless protocol architecture for a user plane.

FIG. 3 is a diagram showing a wireless protocol architecture for a control plane.

FIG. 4 is a flowchart illustrating the operation of UE in the RRC idle state.

FIG. 5 is a flowchart illustrating a process of establishing RRC connection.

FIG. 6 is a flowchart illustrating an RRC connection reconfiguration process.

FIG. 7 is a diagram illustrating an RRC connection re-establishment procedure.

FIG. 8 illustrates substrates which may be owned by UE in the RRC_IDLE state and a substrate transition process.

FIG. 9 shows a basic structure for ProSe.

FIG. 10 shows the deployment examples of types of UE performing ProSe direct communication and cell coverage.

FIG. 11 shows a user plane protocol stack for ProSe direct communication.

FIG. 12 shows the PC 5 interface for D2D direct discovery.

FIG. 13 illustrates a relay user equipment.

FIG. 14 illustrates the relationship between a relay user equipment and a remote user equipment.

FIG. 15 shows an operation method of a user equipment supporting sidelink according to one embodiment of the present invention.

FIG. 16 shows an example in which the embodiment of the present invention is applied.

FIG. 17 and FIG. 18 illustrate more specifically the operation method between a relay user equipment and a remote user equipment and a network according to one embodiment of the present invention.

FIG. 19 is a block diagram illustrating a user equipment in which an embodiment of the present invention is implemented.

### DESCRIPTION OF EXEMPLARY EMBODIMENTS

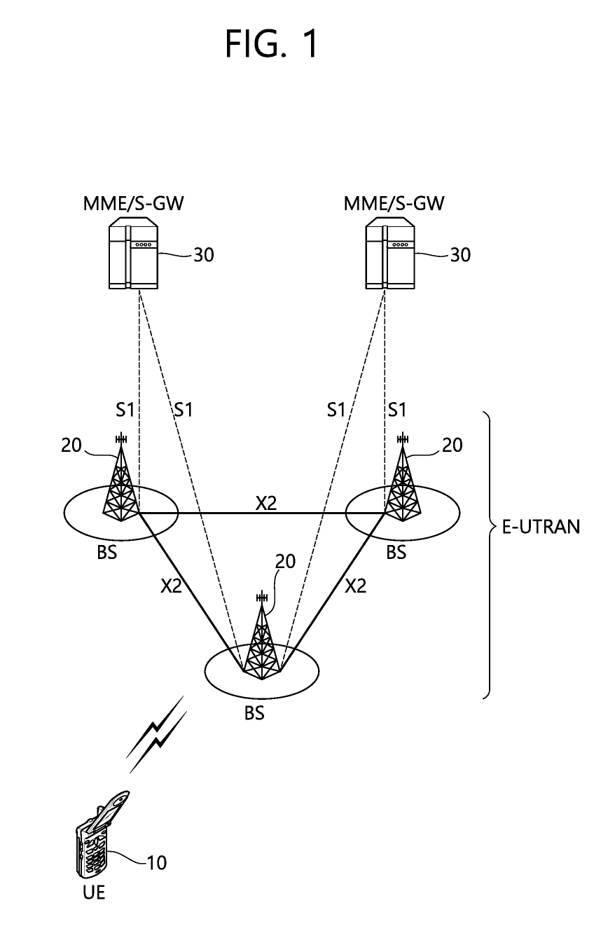

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

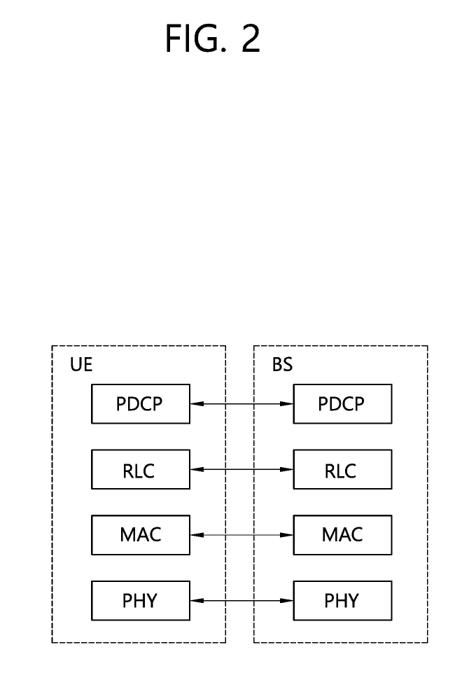

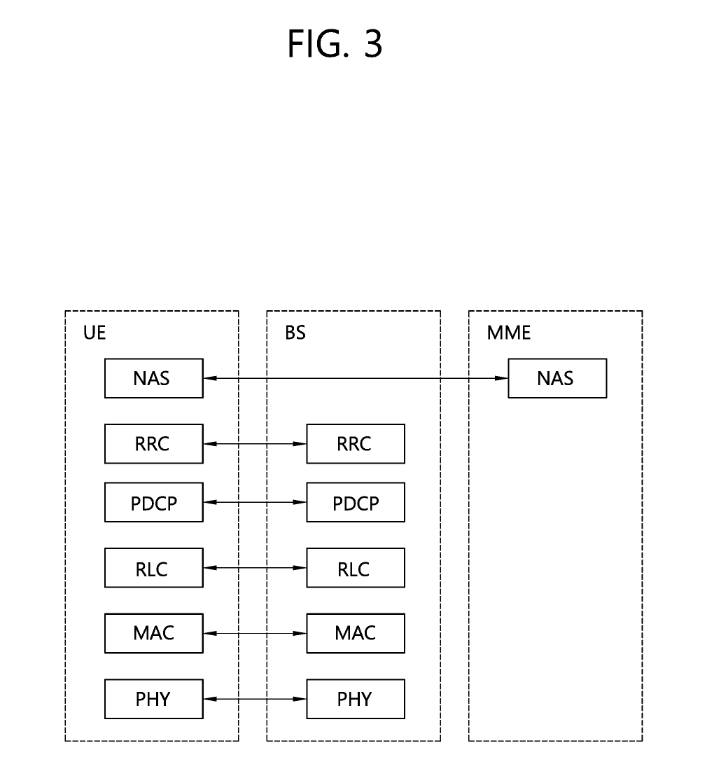

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a process of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes S1 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell. The system information is divided into a Master Information Block (MIB) and a plurality of System Information Blocks (SIBs).

The MIB may include the limited number of parameters which are the most essential and are most frequently transmitted in order to obtain other information from a cell. UE first discovers an MIB after downlink synchronization. The MIB may include information, such as a downlink channel bandwidth, a PHICH configuration, an SFN supporting synchronization and operating as a timing reference, and an eNB transmission antenna configuration. The MIB may be broadcasted on a BCH.

SystemInformationBlockType1 (SIB1) of included SIBs is included in a “SystemInformationBlockType1” message and transmitted. Other SIBs other than the SIB1 are included in a system information message and transmitted. The mapping of the SIBs to the system information message may be flexibly configured by a scheduling information list parameter included in the SIB1. In this case, each SIB is included in a single system information message. Only SIBs having the same scheduling required value (e.g. period) may be mapped to the same system information message. Furthermore, SystemInformationBlockType2 (SIB2) is always mapped to a system information message corresponding to the first entry within the system information message list of a scheduling information list. A plurality of system information messages may be transmitted within the same period. The SIB1 and all of the system information messages are transmitted on a DL-SCH.

In addition to broadcast transmission, in the E-UTRAN, the SIB1 may be channel-dedicated signaling including a parameter set to have the same value as an existing set value. In this case, the SIB1 may be included in an RRC connection re-establishment message and transmitted.

The SIB1 includes information related to UE cell access and defines the scheduling of other SIBs. The SIB1 may include information related to the PLMN identifiers, Tracking Area Code (TAC), and cell ID of a network, a cell barring state indicative of whether a cell is a cell on which UE can camp, a required minimum reception level within a cell which is used as a cell reselection reference, and the transmission time and period of other SIBs.

The SIB2 may include radio resource configuration information common to all types of UE. The SIB2 may include information related to an uplink carrier frequency and uplink channel bandwidth, an RACH configuration, a page configuration, an uplink power control configuration, a sounding reference signal configuration, a PUCCH configuration supporting ACK/NACK transmission, and a PUSCH configuration.

UE may apply a procedure for obtaining system information and for detecting a change of system information to only a PCell. In an SCell, when the corresponding SCell is added, the E-UTRAN may provide all types of system information related to an RRC connection state operation through dedicated signaling. When system information related to a configured SCell is changed, the E-UTRAN may release a considered SCell and add the considered SCell later. This may be performed along with a single RRC connection re-establishment message. The E-UTRAN may set a value broadcast within a considered SCell and other parameter value through dedicated signaling.

UE needs to guarantee the validity of a specific type of system information. Such system information is called required system information. The required system information may be defined as follows.
If UE is in the RRC_IDLE state: the UE needs to have the valid version of the MIB and the SIB1 in addition to the SIB2 to SIB8. This may comply with the support of a considered RAT.
If UE is in the RRC connection state: the UE needs to have the valid version of the MIB, SIB1, and SIB2.

In general, the validity of system information may be guaranteed up to a maximum of 3 hours after being obtained.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG.

3) A barred cell: this cell is a cell that broadcasts information indicative of a barred cell through system information.

4) A reserved cell: this cell is a cell that broadcasts information indicative of a reserved cell through system information.

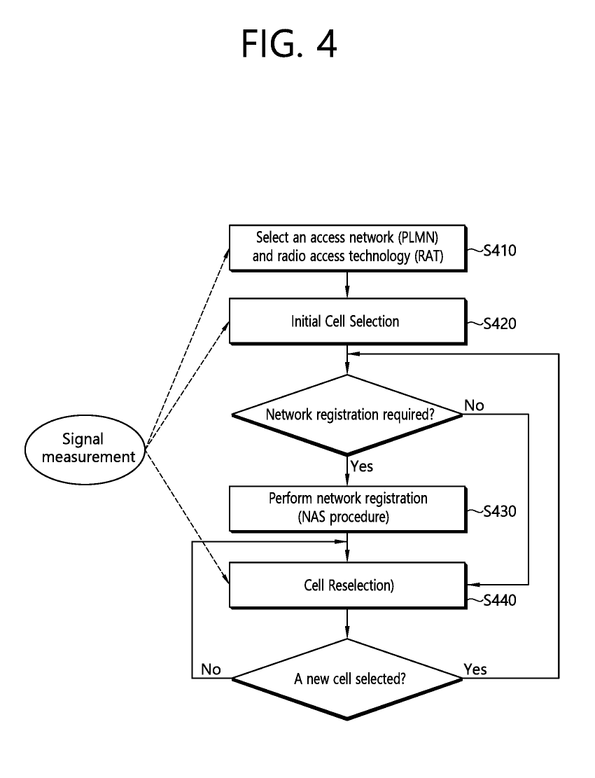

FIG. 4 is a flowchart illustrating the operation of UE in the RRC idle state. FIG. 4 illustrates a procedure in which UE that is initially powered on experiences a cell selection process, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This process is called cell reselection differently from the initial cell selection of the No. 2 process. In this case, temporal restriction conditions are placed in order for a cell to be frequently reselected in response to a change of signal characteristic. A cell reselection procedure is described later in detail.

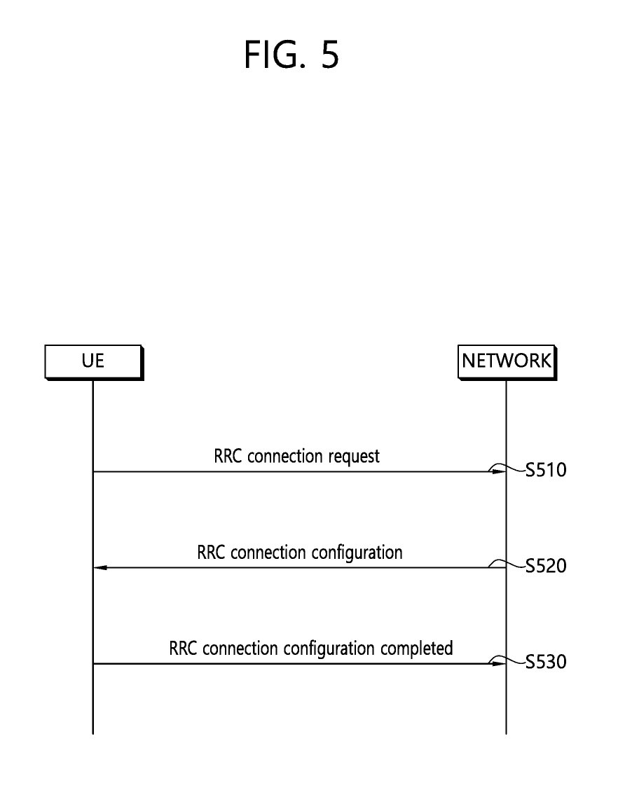

FIG. 5 is a flowchart illustrating a process of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

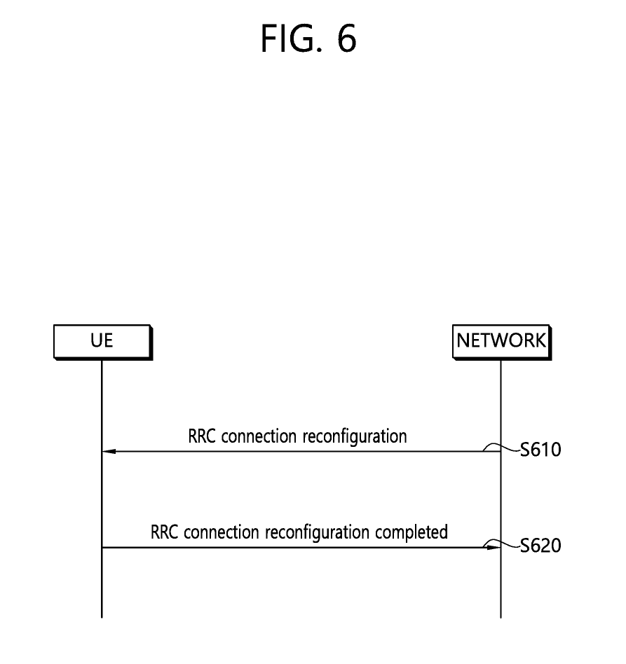

FIG. 6 is a flowchart illustrating an RRC connection reconfiguration process. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC). Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal.

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection process is basically divided into two types.

The first is an initial cell selection process. In this process, UE does not have preliminary information about a wireless channel. Accordingly, the UE searches for all wireless channels in order to find out a proper cell. The UE searches for the strongest cell in each channel. Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection process. If the UE has only to search for a cell that satisfies the cell selection criterion, the UE selects the corresponding cell. If a suitable cell that satisfies the cell selection criterion is not retrieved though such a process, the UE performs an initial cell selection process.

The cell selection criterion may be defined as below equation 1.

Srxlev>0 AND & Squal>0

where:

Srxlev=Qᵣₓₗₑᵥₘₑₐₛ−(Qᵣₓₗₑᵥₘᵢₙ+Q_{rxlevminoffset})−Pcompensation

Squal=Q_{qualmeas}−(Q_{qualmin}+Q_{qualminoffset}) [Equation 1]

Here, the variables in the equation 1 may be defined as below table 1.

TABLE 1

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN |
| Q_{qualminoffset} | Offset to the signalled Q_{qualmin} taken into account in the |
| | Squal evaluation as a result of a periodic search for a |
| | higher priority PLMN while camped normally in a |
| | VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class as defined in [TS 36.101] |

Signalled values, i.e., Q_{rxlevminoffset} and Q_{qualminoffset}, may be applied to a case where cell selection is evaluated as a result of periodic search for a higher priority PLMN during a UE camps on a normal cell in a VPLMN. During the periodic search for the higher priority PLMN as described above, the UE may perform the cell selection evaluation by using parameter values stored in other cells of the higher priority PLMN.

After the UE selects a specific cell through the cell selection process, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a process is called cell reselection. In general, a basic object of the cell reselection process is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection process compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection process is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency.

For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection.

For the intra-frequency or inter-frequency cell reselection, a network may provide UE with a cell reselection black list used in cell reselection. The UE does not perform cell reselection on a cell included in the black list.

Ranking performed in a cell reselection evaluation process is described below.

A ranking criterion used to apply priority to a cell is defined as in Equation 2.

Rs=Qmeas,s+Qhyst, Rn=Qmeas,s−Qoffset [Equation 2]

In this case, Rs is the ranking criterion of a serving cell, Rn is the ranking criterion of a neighbor cell, Qmeas,s is the quality value of the serving cell measured by UE, Qmeas,n is the quality value of the neighbor cell measured by UE, Qhyst is the hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell reselection.

A Radio Link Failure (RLF) is described below.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

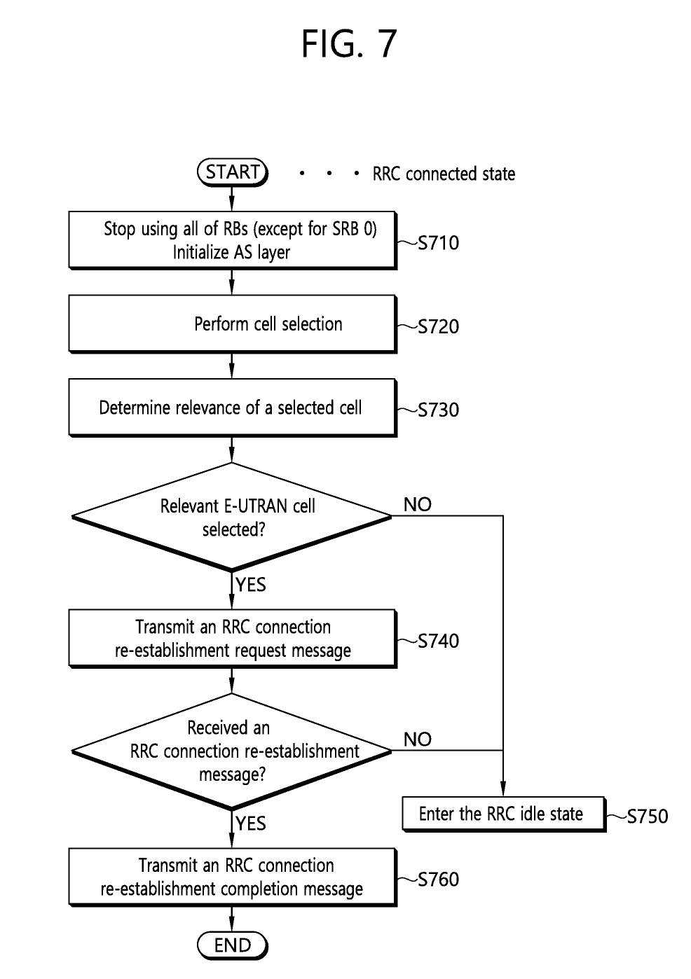

FIG. 7 is a diagram illustrating an RRC connection re-establishment procedure.

Referring to FIG. 7, UE stops using all the radio bearers that have been configured other than a Signaling Radio Bearer (SRB) #0, and initializes a variety of kinds of sublayers of an Access Stratum (AS) (S710). Furthermore, the UE configures each sublayer and the PHY layer as a default configuration. In this process, the UE maintains the RRC connection state.

The UE performs a cell selection procedure for performing an RRC connection reconfiguration procedure (S720). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S730). If the selected cell is determined to be a suitable E-UTRAN cell, the UE sends an RRC connection re-establishment request message to the corresponding cell (S740).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S750).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S760).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

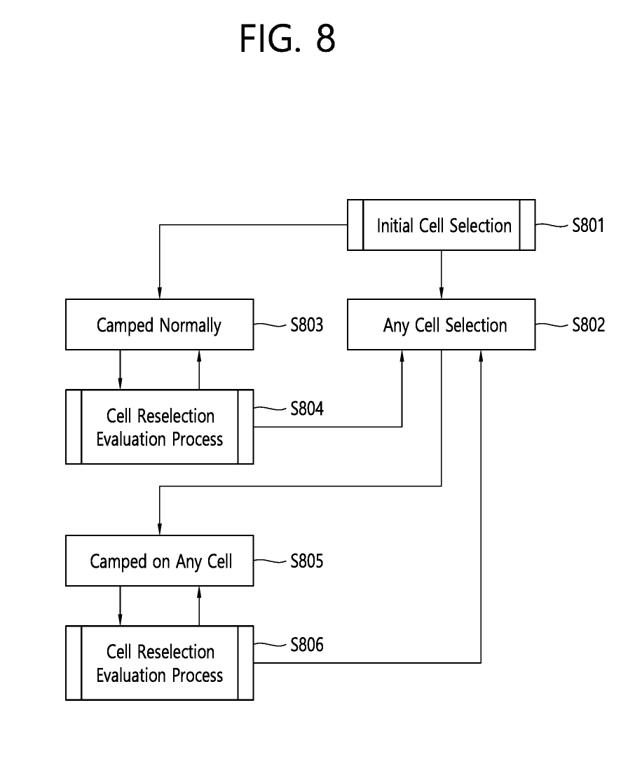

FIG. 8 illustrates substrates which may be owned by UE in the RRC_IDLE state and a substrate transition process.

Referring to FIG. 8, UE performs an initial cell selection process (S801). The initial cell selection process may be performed when there is no cell information stored with respect to a PLMN or if a suitable cell is not discovered.

If a suitable cell is unable to be discovered in the initial cell selection process, the UE transits to any cell selection state (S802). The any cell selection state is the state in which the UE has not camped on a suitable cell and an acceptable cell and is the state in which the UE attempts to discover an acceptable cell of a specific PLMN on which the UE may camp. If the UE has not discovered any cell on which it may camp, the UE continues to stay in the any cell selection state until it discovers an acceptable cell.

If a suitable cell is discovered in the initial cell selection process, the UE transits to a normal camp state (S803). The normal camp state refers to the state in which the UE has camped on the suitable cell. In this state, the UE may select and monitor a paging channel based on information provided through system information and may perform an evaluation process for cell reselection.

If a cell reselection evaluation process (S804) is caused in the normal camp state (S803), the UE performs a cell reselection evaluation process (S804). If a suitable cell is discovered in the cell reselection evaluation process (S804), the UE transits to the normal camp state (S803) again.

If an acceptable cell is discovered in the any cell selection state (S802), the UE transmits to any cell camp state (S805). The any cell camp state is the state in which the UE has camped on the acceptable cell.

In the any cell camp state (S805), the UE may select and monitor a paging channel based on information provided through system information and may perform the evaluation process (S806) for cell reselection. If an acceptable cell is not discovered in the evaluation process (S806) for cell reselection, the UE transits to the any cell selection state (S802).

Now, a device-to-device (D2D) operation is described. In 3GPP LTE-A, a service related to the D2D operation is called a proximity service (ProSe). Now, the ProSe is described. Hereinafter, the ProSe is the same concept as the D2D operation, and the ProSe and the D2D operation may be used without distinction.

The ProSe includes ProSe direction communication and ProSe direct discovery. The ProSe direct communication is communication performed between two or more proximate UEs. The UEs may perform communication by using a protocol of a user plane. A ProSe-enabled UE implies a UE supporting a procedure related to a requirement of the ProSe. Unless otherwise specified, the ProSe-enabled UE includes both of a public safety UE and a non-public safety UE. The public safety UE is a UE supporting both of a function specified for a public safety and a ProSe procedure, and the non-public safety UE is a UE supporting the ProSe procedure and not supporting the function specified for the public safety.

ProSe direct discovery is a process for discovering another ProSe-enabled UE adjacent to ProSe-enabled UE. In this case, only the capabilities of the two types of ProSe-enabled UE are used. EPC-level ProSe discovery means a process for determining, by an EPC, whether the two types of ProSe-enabled UE are in proximity and notifying the two types of ProSe-enabled UE of the proximity.

Hereinafter, for convenience, the ProSe direct communication may be referred to as D2D communication, and the ProSe direct discovery may be referred to as D2D discovery.

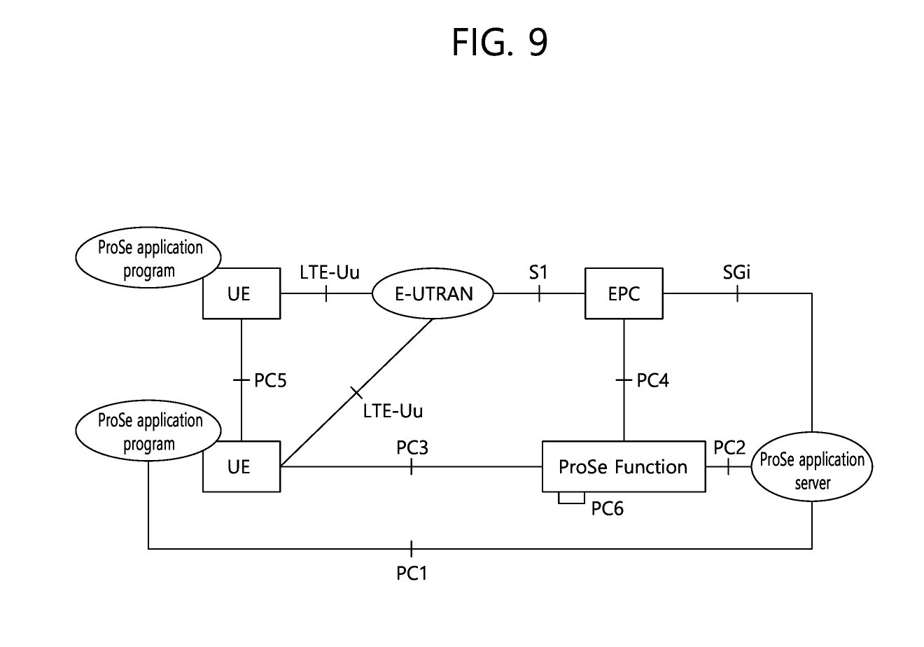

FIG. 9 shows a basic structure for ProSe.

Referring to FIG. 9, the basic structure for ProSe includes an E-UTRAN, an EPC, a plurality of types of UE including a ProSe application program, a ProSe application server (a ProSe APP server), and a ProSe function.

The EPC represents an E-UTRAN core network configuration. The EPC may include an MME, an S-GW, a P-GW, a policy and charging rules function (PCRF), a home subscriber server (HSS) and so on.

The ProSe APP server is a user of a ProSe capability for producing an application function. The ProSe APP server may communicate with an application program within UE. The application program within UE may use a ProSe capability for producing an application function.

The ProSe function may include at least one of the followings, but is not necessarily limited thereto.
Interworking via a reference point toward the 3rd party applications
Authorization and configuration of UE for discovery and direct communication
Enable the functionality of EPC level ProSe discovery
ProSe related new subscriber data and handling of data storage, and also handling of the ProSe identities
Security related functionality
Provide control towards the EPC for policy related functionality
Provide functionality for charging (via or outside of the EPC, e.g., offline charging)

A reference point and a reference interface in the basic structure for ProSe are described below.
PC1: a reference point between the ProSe application program within the UE and the ProSe application program within the ProSe APP server. This is used to define signaling requirements in an application dimension.
PC2: a reference point between the ProSe APP server and the ProSe function. This is used to define an interaction between the ProSe APP server and the ProSe function. The update of application data in the ProSe database of the ProSe function may be an example of the interaction.
PC3: a reference point between the UE and the ProSe function. This is used to define an interaction between the UE and the ProSe function. A configuration for ProSe discovery and communication may be an example of the interaction.
PC4: a reference point between the EPC and the ProSe function. This is used to define an interaction between the EPC and the ProSe function. The interaction may illustrate the time when a path for 1:1 communication between types of UE is set up or the time when ProSe service for real-time session management or mobility management is authenticated.
PC5: a reference point used for using control/user plane for discovery and communication, relay, and 1:1 communication between types of UE.
PC6: a reference point for using a function, such as ProSe discovery, between users belonging to different PLMNs.
SGi: this may be used to exchange application data and types of application dimension control information.

<ProSe Direct Communication>

ProSe direct communication is communication mode in which two types of public safety UE can perform direct communication through a PC 5 interface. Such communication mode may be supported when UE is supplied with services within coverage of an E-UTRAN or when UE deviates from coverage of an E-UTRAN.

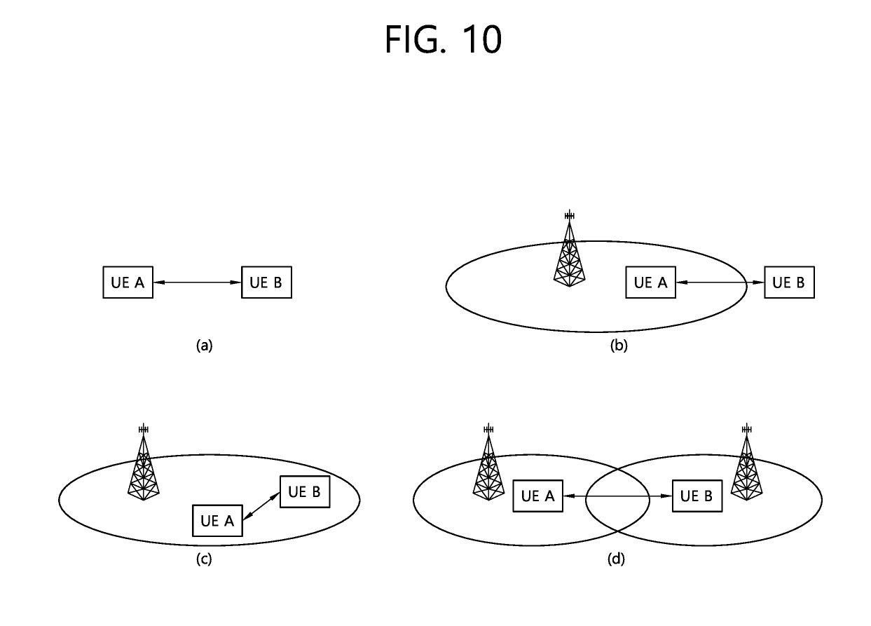

FIG. 10 shows the deployment examples of types of UE performing ProSe direct communication and cell coverage.

Referring to FIG. 10(a), types of UE A and B may be placed outside cell coverage. Referring to FIG. 10(b), UE A may be placed within cell coverage, and UE B may be placed outside cell coverage. Referring to FIG. 10(c), types of UE A and B may be placed within single cell coverage. Referring to FIG. 10(d), UE A may be placed within coverage of a first cell, and UE B may be placed within coverage of a second cell.

ProSe direct communication may be performed between types of UE placed at various positions as in FIG. 10.

Meanwhile, the following IDs may be used in ProSe direct communication.

A source layer-2 ID: this ID identifies the sender of a packet in the PC 5 interface.

A destination layer-2 ID: this ID identifies the target of a packet in the PC 5 interface.

An SA L1 ID: this ID is the ID of scheduling assignment (SA) in the PC 5 interface.

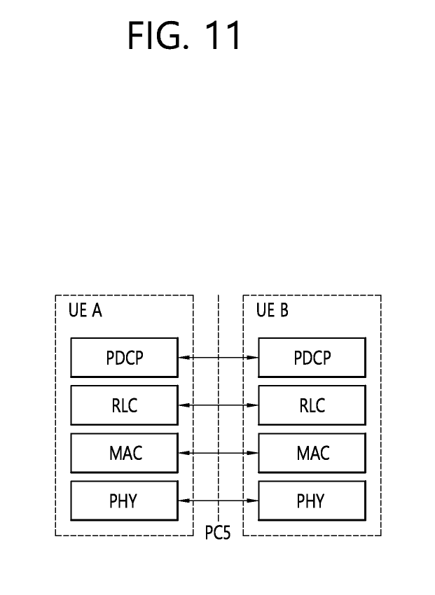

FIG. 11 shows a user plane protocol stack for ProSe direct communication.

Referring to FIG. 11, the PC 5 interface includes a PDCH, RLC, MAC, and PHY layers.

In ProSe direct communication, HARQ feedback may not be present. An MAC header may include a source layer-2 ID and a destination layer-2 ID.

<Radio resource assignment for ProSe direct communication>

ProSe-enabled UE may use the following two types of mode for resource assignment for ProSe direct communication.

1. Mode 1

Mode 1 is mode in which resources for ProSe direct communication are scheduled by an eNB. UE needs to be in the RRC_CONNECTED state in order to send data in accordance with mode 1. The UE requests a transmission resource from an eNB. The eNB performs scheduling assignment and schedules resources for sending data. The UE may send a scheduling request to the eNB and send a ProSe Buffer Status Report (BSR). The eNB has data to be subjected to ProSe direct communication by the UE based on the ProSe BSR and determines that a resource for transmission is required.

2. Mode 2

Mode 2 is mode in which UE directly selects a resource. UE directly selects a resource for ProSe direct communication in a resource pool. The resource pool may be configured by a network or may have been previously determined.

Meanwhile, if UE has a serving cell, that is, if the UE is in the RRC_CONNECTED state with an eNB or is placed in a specific cell in the RRC_IDLE state, the UE is considered to be placed within coverage of the eNB.

If UE is placed outside coverage, only mode 2 may be applied. If the UE is placed within the coverage, the UE may use mode 1 or mode 2 depending on the configuration of an eNB.

If another exception condition is not present, only when an eNB performs a configuration, UE may change mode from mode 1 to mode 2 or from mode 2 to mode 1.

<ProSe Direct Discovery>

ProSe direct discovery refers to a procedure that is used for ProSe-enabled UE to discover another ProSe-enabled UE in proximity and is also called D2D direct discovery. In this case, E-UTRA radio signals through the PC 5 interface may be used. Information used in ProSe direct discovery is hereinafter called discovery information.

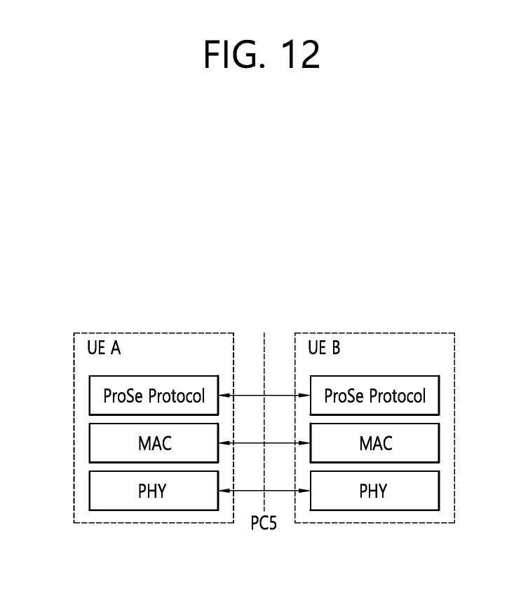

FIG. 12 shows the PC 5 interface for D2D direct discovery.

Referring to FIG. 12, the PC 5 interface includes an MAC layer, a PHY layer, and a ProSe Protocol layer, that is, a higher layer. The higher layer (the ProSe Protocol) handles the permission of the announcement and monitoring of discovery information. The contents of the discovery information are transparent to an access stratum (AS). The ProSe Protocol transfers only valid discovery information to the AS for announcement.

The MAC layer receives discovery information from the higher layer (the ProSe Protocol). An IP layer is not used to send discovery information. The MAC layer determines a resource used to announce discovery information received from the higher layer. The MAC layer produces an MAC protocol data unit (PDU) for carrying discovery information and sends the MAC PDU to the physical layer. An MAC header is not added.

In order to announce discovery information, there are two types of resource assignment.

1. Type 1

The type 1 is a method for assigning a resource for announcing discovery information in a UE-not-specific manner. An eNB provides a resource pool configuration for discovery information announcement to types of UE. The configuration may be signaled through the SIB.

UE autonomously selects a resource from an indicated resource pool and announces discovery information using the selected resource. The UE may announce the discovery information through a randomly selected resource during each discovery period.

2. Type 2

The type 2 is a method for assigning a resource for announcing discovery information in a UE-specific manner. UE in the RRC_CONNECTED state may request a resource for discovery signal announcement from an eNB through an RRC signal. The eNB may announce a resource for discovery signal announcement through an RRC signal. A resource for discovery signal monitoring may be assigned within a resource pool configured for types of UE.

An eNB 1) may announce a type 1 resource pool for discovery signal announcement to UE in the RRC_IDLE state through the SIB. Types of UE whose ProSe direct discovery has been permitted use the type 1 resource pool for discovery information announcement in the RRC_IDLE state. Alternatively, the eNB 2) announces that the eNB supports ProSe direct discovery through the SIB, but may not provide a resource for discovery information announcement. In this case, UE needs to enter the RRC_CONNECTED state for discovery information announcement.

An eNB may configure that UE has to use a type 1 resource pool for discovery information announcement or has to use a type 2 resource through an RRC signal in relation to UE in the RRC_CONNECTED state.

In the following, sidelink may refer to the interface between user equipments for D2D communication and D2D discovery. The sidelink corresponds to the PC5 interface described above. The channel defined/used by the sidelink is the Physical Sidelink Control Channel: PSCCH. A control channel that is used to broadcast the most basic system information for D2D communication is the Physical Sidelink Broadcast Channel (PSBCH). Also, the channel used for transmitting the D2D discovery signal may be defined as a Physical Sidelink Discovery Channel (PSDCH). The D2D synchronization signal may be referred to as a SideLink Synchronization Signal (SLSS) or a D2D Synchronization Signal (D2DSS).

In the LTE-A system (Rel-12, 13 or higher), the D2D communication user equipment is configured to transmit the PSBCH and the SLSS together or to transmit only the SLSS. Also, in LTE-A system, S-RSRP (Sidelink RSRP) is newly defined to synchronize between user equipments in D2D communication. In other words, when user equipments want to communicate in D2D, S-RSRP thereof may be measured. It is possible to synchronize with each other between user equipments having a value higher than a certain S-RSRP value, and then perform D2D communication between them. In this connection, S-RSRP may be measured from the demodulation reference signal: DM-RS on the PSBCH. However, for D2D relay operation, the S-RSRP may be measured from the DM-RS on the PSDCH.

Further, the user equipment outside the cell coverage measures the S-RSRP based on the SLSS and/or the DM-RS of the PSBCH/PSCCH/PSSCH. Thus, the user equipment may determine whether or not to be a synchronization source to perform the D2D relay operation.

Hereinafter, the D2D relay operation may be referred to simply as a relay operation, and a user equipment that performs D2D relay operation is called a relay user equipment. The relay user equipment may be located between the first user equipment and the second user equipment, and may relay signals between the first and second user equipments. Alternatively, a relay user equipment may be located between another user equipment and a network (cell/base station), and may relay signals between another user equipment and the network. Hereinafter, a relay user equipment is assumed to be a user equipment that relays signals between another user equipment and the network.

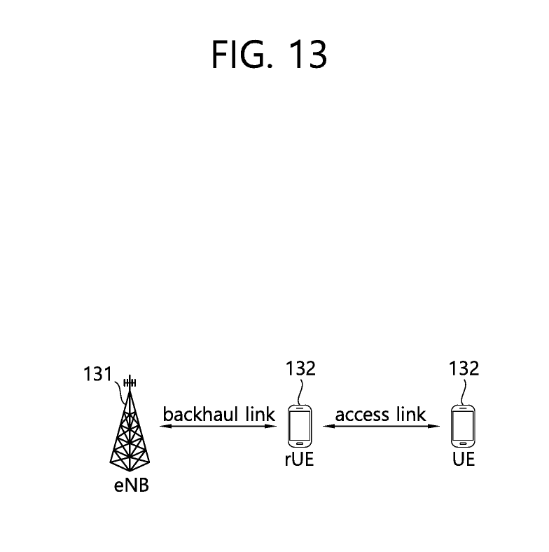

FIG. 13 illustrates a relay user equipment.

The relay user equipment 132 is a user equipment that provides network connectivity to the remote user equipment 133. The relay user equipment 132 is responsible for relaying signals between the remote user equipment 133 and the network 131. The remote user equipment 133 may be a user equipment (UE) that is difficult to communicate directly with the base station, even when the remote user equipment 133 is located outside of the coverage of the base station or within coverage thereof.

The relay user equipment maintains a link to a base station as well as a link to a common user equipment (e.g. remote UE). In this state, the relay user equipment may transmit information received from the base station to the common user equipment or may transmit information received from the common user equipment to the base station. In this connection, the link between the base station and the relay user equipment is called the backhaul link, and a link between the relay user equipment and the remote user equipment is also referred to as an access link. Further, a link used to perform direct communication between the user equipments without involvement of the base station may be defined as a D2D link or sidelink.

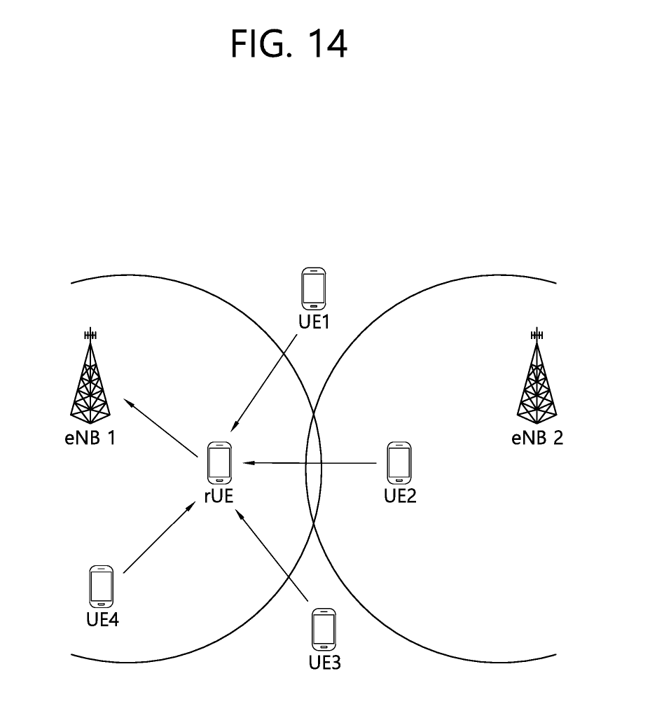

FIG. 14 illustrates the relationship between a relay user equipment and a remote user equipment.

In FIG. 14, UE1 and UE3 are user equipments outside the coverage, and UE2 and UE4 are user equipments in the coverage, and rUE is a relay user equipment configured to perform relay operations. In this connection, the UE2 may be in the coverage of the second base station (eNB2) and may be outside the coverage of the first base station (eNB1). For the rUE, the first base station (eNB1) may be the serving cell.

The rUE may be configured as rUE by instruction of the first base station (eNB1) or coordination between rUEs. The rUE broadcasts a discovery signal, whereby neighboring UEs may be aware of the presence of the rUE. The rUE receives the D2D signal from the user equipment (i.e. UE4) in the serving cell network for uplink transmission, the user equipment (i.e. UE2) in the neighboring cell network, and the user equipments outside the coverage (i.e. UE1, UE3).

Hereinafter, a procedure for selecting a relay user equipment by a remote user equipment will be described in detail. Further, the following will describe what operation/procedure the remote user equipment performs in its protocol layers when the remote user equipment selects the relay user equipment.

The procedure for selecting the relay user equipment by the remote user equipment may include three major steps, where different levels of RAN auxiliary information and control information may be provided for and between the three steps. The remote user equipment may be within the coverage of the base station or outside coverage. Whether the remote user equipment is within the coverage of the base station or outside coverage may affect the level that the base station controls.

<Step 1: Configuration of Relay User Equipment>

In order for the candidate relay user equipment to participate in the discovery operation and to perform the relay operation between the remote user equipment and the network, it may be necessary for the candidate relay user equipment to receive authentication from the network that the candidate device may act as a relay device between the remote user equipment and the network. Therefore, the candidate relay user equipment may need to enter the RRC connection state and be authorized from the network (base station) to act as the relay user equipment.

Further, there are two available methods for discovery (called relay discovery) transmitted by the relay user equipment. That is, there may be a relay discovery transmission initiated from the relay user equipment and a relay discovery transmission initiated from the remote user equipment. Which of the two methods are used may be configured/controlled by the base station.

That is, in order for the relay user equipment to participate in the discovery operation and to perform the relay operation between the remote user equipment and the network, the relay user equipment may need to enter the RRC connection state and be authorized from the network (base station) to act as the relay user equipment.

<Step 2: Relay Discovery Assisted by the Network>

In step 2, if the remote user equipment is outside the cell coverage, the remote user equipment performs an evaluation of candidate relay user equipments. If the remote user equipment is within the cell coverage, selecting a relay user equipment among the candidate relay user equipments may be performed by the serving cell of the remote user equipment based on the measurement report received from the remote user equipment or candidate relay user equipments. In this example, it may be assumed that the remote user equipment is outside the cell coverage, and that the relay user equipment selection is performed by the remote user equipment.

The selection criterion of the relay user equipment may include parameters for the connectivity of the candidate relay user equipment (e.g. APN information) and measurement results (for example, RSRP/RSRQ of the sidelink) thereof.

<Step 3: Establishing a secure layer-2 link via PC5 interface>

In step 3, a unicast connection is established between the remote user equipment and the relay user equipment via the PC5 interface. This procedure may include authentication and security configuration procedures. The security configuration of this procedure may be processed by SA3.

On the other hand, in terms of RAN, there are four cases related to the mobility of the remote user equipment.

<Case 1: When the Remote User Equipment in the Cell Connects to the Relay User Equipment>

Intra-E-UTRAN-Access Mobility Support in ECM connection state for user equipments may be composed of handover procedure and Dual Connectivity related procedure. In the handover procedure, the source base station (source eNB) issues a decision/command that causes the user equipment to use the radio resource provided by the target base station. Similarly, in a dual connection related procedure, the decision/command for the user equipment to use the radio resource provided by the SeNB (Secondary eNB) may be issued by the MeNB (Master eNB).

The mobility between RATs is controlled by the network, and this control is performed by the source base station. That is, the decision/command that causes the user equipment to use the target RAT radio resource may be issued by the source base station.

Therefore, mobility for a user equipment in the RRC connected state is based on handover by control of the network under the assistance of the user equipment. This control is performed by the base station, using a combination of system information and dedicated message (RRC connection reconfiguration).

A relay user equipment that relays transmission from a remote user equipment to the network may be considered as another target by the remote user equipment. The source base station may decide to use the relay user equipment that performs handover between RATs or relay from the remote user equipment to the network when the remote user equipment is in the RRC connection state. The source base station may need measurement results to make this decision.

The user equipment in the cell coverage may be in the RRC idle state or RRC connection state based on the activation level of the user equipment. When the user equipment is in the RRC connection state, the user equipment may send and receive data while maintaining service continuity without loss of data using handover under control of the network. In this regard, the remote user equipment in the RRC connection state may be connected to the relay user equipment under the control of the network. Since the user equipment in the RRC idle state does not send or receive data, the user equipment will not need to establish a connection with the relay user equipment. Therefore, the user equipment in the RRC idle state will first need to enter the RRC connection state.

When choosing a relay user equipment within a cell coverage, the degree to which the base station is involved in controlling this selection may vary. The extent to which the base station participates in the control of the selection may be divided into levels 0, 1, 2, and 3.

Level 0: The remote user equipment may choose a relay user equipment according to its implementation. If data is no longer transmitted on the Uu interface between the base station and the user equipment, the deactivation timer releases the remote user equipment.

Level 1: The remote user equipment may choose a relay user equipment based on the parameters contained in the system information provided by the base station. If data is no longer transmitted on the Uu interface between the base station and the user equipment, the deactivation timer releases the remote user equipment.

Level 2: The remote user equipment may select a relay user equipment based on the parameters included in the dedicated signal provided by the base station. The deactivation timer releases the remote user equipment if data is no longer transmitted on the Uu interface between the base station and the user equipment.

Level 3: The remote user equipment reports to the base station the measurement results for the candidate relay user equipment satisfying the minimum condition. The base station selects a relay user equipment among the candidate relay user equipments and handover the remote user equipment to the selected relay user equipment. The handover may be indicated using an RRC connection reconfiguration message or an RRC release message.

According to level 3, since the relay user equipment is selected by the base station, the maximum flexibility and the consistency with the conventional operation may be maintained as much as possible.

The minimum condition may be as follows: 1. The connectivity provided by the relay user equipment satisfies the requirements provided by the higher layer, 2. The sidelink measurement quality (e.g. sidelink RSRQ), as measured by measuring the discovery signal received from the relay user equipment by the remote user equipment should be greater than the preconfigured threshold value; etc.

<Case 2: When the Remote User Equipment Connected to the Relay User Equipment Selects Another Relay User Equipment and Connects to the Selected Device>

In this case, the remote user equipment may be a user equipment outside the cell coverage. The remote user equipment may also perform a relay user equipment reselection procedure. The relay user equipment reselection procedure may be composed of the following three procedures.

1. In the first procedure, a set of relay user equipments (called the candidate set) is maintained that meets the minimum requirements such that connectivity and sidelink measurements exceed a predetermined threshold value. To do this, the remote user equipment may use a discovery operation.

2. In the second procedure, if the currently connected relay user equipment does not satisfy the minimum condition, the currently connected relay user equipment may be excluded from the candidate set, and, then, a reselection procedure for selecting another relay user equipment from the candidate set may be triggered. In this connection, a timer and/or hysteresis may be used before excluding the currently connected relay user equipment from the candidate set.

3. In a third procedure, the relay user equipment reselection may be performed using any of the following:

a. The remote user equipment ranks the candidate relay user equipments included in the candidate set. The remote device may select the highest ranked candidate relay user equipment as the relay user equipment. This ranking may be based on the sidelink RSRP measurement between the corresponding candidate relay user equipment and the remote user equipment.

b. The remote user equipment may select, as the relay user equipment, a candidate relay user equipment randomly selected from the candidate relay user equipments included in the candidate set.

c. The remote user equipment selects the relay user equipment from the candidate relay user equipments included in the candidate set based on the user equipment implementation. That is, the remote user equipment selects the relay user equipment according to its implementation.

The parameters used in the minimum condition to determine the candidate relay user equipment included in the candidate set may be preconfigured or signaled by the network. Among the methods described in a, b, and c above, the “a” method, that is, the method for ranking the candidate relay user equipments may have advantages in that the parameters used for ranking the candidate devices may be preconfigure or may be controlled by the network. Which of the methods a, b, and c as described above is to be used may be predefined or may be configured by the network.

<Case 3: When a Remote User Equipment Connected to a Relay User Equipment Enters Cell Coverage>

In this case, the remote user equipment performs E-UTRAN cell selection. Depending on the EMM state, the user equipment may trigger an RRC connection establishment procedure. For example, the user equipment may trigger the RRC connection establishment procedure to perform a tracking area (TA) update.

When a remote user equipment connected to a relay user equipment enters cell coverage of a specific base station outside of cell coverage and this entry is detected, the remote user equipment change from a state in which the remote device receives a service from the relay device to a change in which the remote device receives a service from the specific base station.

<Case 4: When the Remote User Equipment Outside the Cell Coverage is Connected to the Relay User Equipment>

In this case, the remote user equipment may perform an initial relay user equipment selection procedure consisting of the following two steps.

1. The remote device generates a set of relay user equipments (called a candidate set) that meets the minimum requirements, such as, that connectivity and sidelink measurements exceeds a predetermined threshold value. To this end, the remote user equipment may perform a sidelink discovery operation, i.e., a procedure in which the remote user equipment attempts to receive a sidelink discovery signal sent by the relay user equipment.

2. The remote device selects a relay user equipment. The relay user equipment selection procedure may follow any one of the following methods.

a. The remote user equipment ranks the candidate relay user equipments included in the candidate set. The remote device may select the highest ranked candidate relay user equipment as the relay user equipment. This ranking may be based on the sidelink RSRP (SD-RSRP) measurement between the corresponding candidate relay user equipment and the remote user equipment.

b. The remote user equipment may select, as the relay user equipment, a candidate relay user equipment randomly selected from the candidate relay user equipments included in the candidate set.

c. The remote user equipment selects the relay user equipment from the candidate relay user equipments included in the candidate set based on the user equipment implementation. That is, the remote user equipment selects the relay user equipment according to its implementation.

The parameters used in the minimum condition to determine the candidate relay user equipment included in the candidate set may be preconfigured or signaled by the network. Among the methods described in a, b, and c above, the “a” method, that is, the method for ranking the candidate relay user equipments may have advantages in that the parameters used for ranking the candidate devices may be preconfigure or may be controlled by the network. Which of the methods a, b, and c as described above is to be used may be predefined or may be configured by the network.

Now, the present invention will be described.

The serving cell of the relay user equipment and the serving cell of the remote user equipment may be the same or different. Although the remote user equipment and the relay user equipment are in the same serving cell, when the remote user equipment is in a poor communication environment, such as in tunnels, underground areas, or other areas of weak coverage, the remote user equipment may require relay service via the relay user equipment.

If the serving cell of the relay user equipment and the serving cell of the remote user equipment are different, it may be necessary for the network to control whether a relay service between the relay user equipment and the remote user equipment is to be embodied, based on whether cooperation between the serving cells is present or not.

To enable this network control, the network needs to know which user equipment may operate as a relay user equipment in the cell, via the sidelink user equipment ID of the user equipment. The sidelink user equipment ID may or may not be the same as the user equipment ID used in typical cellular communications. That is, for the same user equipment, the user equipment ID used in cellular communication with the base station and the user equipment ID used in the sidelink may be the same or different. The sidelink user equipment ID may be used by the network to control sidelink usage. The control of the sidelink use by the network may include scheduling of the user equipment with respect to the use of the sidelink.

Further, in order to enable the aforementioned network control, the network needs to know which user equipment is operating as a remote user equipment in the cell via the sidelink user equipment ID of the user equipment.

Methods for implementing this scheme are described below.

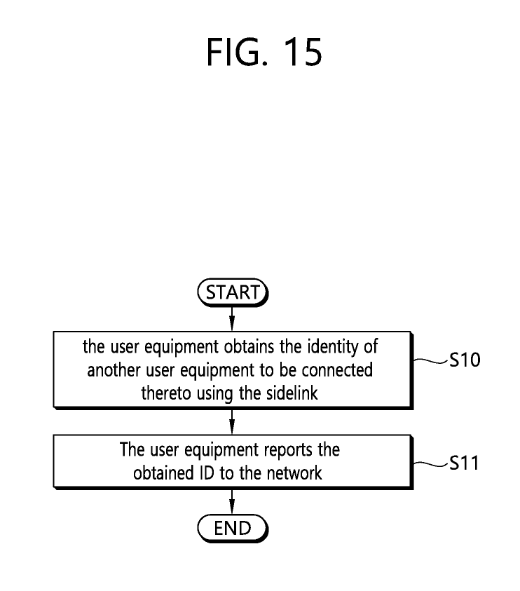

FIG. 15 shows an operation method of a user equipment supporting sidelink according to one embodiment of the present invention.

Referring to FIG. 15, the user equipment obtains the identity of another user equipment to be connected thereto using the sidelink (S10). In this connection, the user equipment may be a user equipment attempting to provide a relay service between said another user equipment and the network.

For convenience, the user equipment is referred to as a relay user equipment, and the another user equipment is referred to as a remote user equipment. The relay user equipment obtains the sidelink user equipment ID being used by the remote user equipment requiring the relay service. For example, the relay device may receive a sidelink communication request message from the remote user equipment or receive a sidelink discovery message therefrom. The sidelink user equipment ID of the remote user equipment may be included in the message. The relay device may obtain the sidelink user equipment ID of the remote user equipment from the message.

The user equipment reports the obtained ID to the network (S20).

For example, the user equipment may report the sidelink user equipment ID of said another user equipment to the network using the sidelink UE information (SidelinkUEInformation) message. In this connection, the sidelink user equipment ID of the user equipment (relay user equipment) may be included in the sidelink user equipment or the UE information.

The following table is a specific example of the sidelink UE information (message).

TABLE 2
-- ASN1START

| SidelinkUEInformation-r12 ::= | | SEQUENCE { |
|---|---|---|
| | criticalExtensions | CHOICE { |

| | |
|---|---|
| c1 | CHOICE { |

| | |
|---|---|
| sidelinkUEInformation-r12 | SidelinkUEInformation-r12-IEs, |

| spare3 NULL, spare2 NULL, spare1 NULL | |
|---|---|
| }, | |
| criticalExtensionsFuture | SEQUENCE { } |

}

}

| SidelinkUEInformation-r12-IEs ::= | | SEQUENCE { | |
|---|---|---|---|
| | commRxInterestedFreq-r12 | ARFCN-ValueEUTRA-r9 | OPTIONAL, |
| | commTxResourceReq-r12 | SL-CommTxResourceReq-r12 | OPTIONAL, |
| | discRxInterest-r12 | ENUMERATED {true} | OPTIONAL, |

| | | |
|---|---|---|
| discTxResourceReq-r12 | INTEGER (1..63) | OPTIONAL, |
| destinationUEID | Remote UE L2 ID | OPTIONAL, |
| sourceUEID | Relay UE L2 ID | OPTIONAL, |

| | | |
|---|---|---|
| lateNonCriticalExtension | OCTET STRING | OPTIONAL, |

| | | |
|---|---|---|
| nonCriticalExtension | SEQUENCE { } | OPTIONAL |

}

| SL-CommTxResourceReq-r12 ::= | | SEQUENCE { |
|---|---|---|
| | carrierFreq-r12 | ARFCN-ValueEUTRA-r9 |
| | OPTIONAL, | |
| | destinationInfoList-r12 | SL-DestinationInfoList-r12 |

}
SL-DestinationInfoList-r12 ::= SEQUENCE (SIZE (1..maxSL-Dest-r12)) OF SL-DestinationIdentity-r12

| | |
|---|---|
| SL-DestinationIdentity-r12 ::= | BIT STRING (SIZE (24)) |

-- ASN1STOP

The ‘commRxInterestedFreq’ in the sidelink UE information transmitted by the user equipment indicates a frequency at which the user equipment is interested in receiving the sidelink communication (D2D communication) signal. The ‘commTxResourceReq’ may indicate the frequency at which the user equipment is interested in transmitting the sidelink communication signal, and the destination of the sidelink communication signal. The ‘discRxInterest’ indicates whether the user equipment is interested in monitoring the sidelink discovery announcement. The ‘discTxResourceReq’ indicates the number of resources requested by the user equipment to transmit the sidelink discovery announcement at every discovery period. The ‘destinationInfoList’ indicates the destination identified by the group ID of ProSe layer 2. The ‘destinationUEID’ may represent the user equipment ID (sidelink user equipment ID) of the ProSe layer 2 of the user equipment receiving the relay service, that is, the remote user equipment. The ‘sourceUEID’ may indicate the user equipment ID (sidelink user equipment ID) of the ProSe layer 2 of the source user equipment for the relay service, that is, the user equipment transmitting the sidelink UE information.

The source user equipment ID information may be included in the sidelink UE information message even when the sidelink UE information message is not for requesting the transmission resource/configuration for the sidelink.

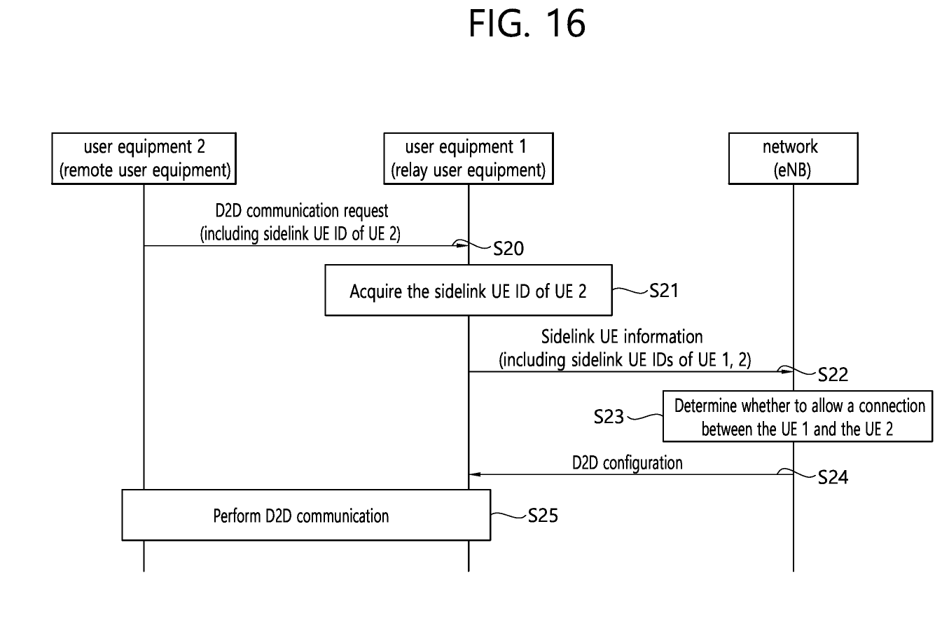

FIG. 16 shows an example in which the embodiment of the present invention is applied.

Referring to FIG. 16, the user equipment 1 receives a D2D communication request from the user equipment 2 (S20). The sidelink user equipment ID of the user equipment 2 may be included in the D2D communication request.

The user equipment 1 acquires the sidelink user equipment ID for the user equipment 2 (S21).

The user equipment 2 provides the sidelink ID for the user equipments 1 and 2 to the network using the sidelink user equipment or the UE information (S22).

The network determines whether to allow a connection between the user equipment 1 and the user equipment 2 (S23). For example, the network determines whether to configure the user equipment 1 as a relay user equipment for the user equipment 2.

When the network decides to configure the user equipment 1 as a relay user equipment for the user equipment 2, the network provides the D2D configuration for the relay service to the user equipment 1 (S24).

The user equipment 1 performs D2D communication with the user equipment 2 based on the D2D configuration (S25).

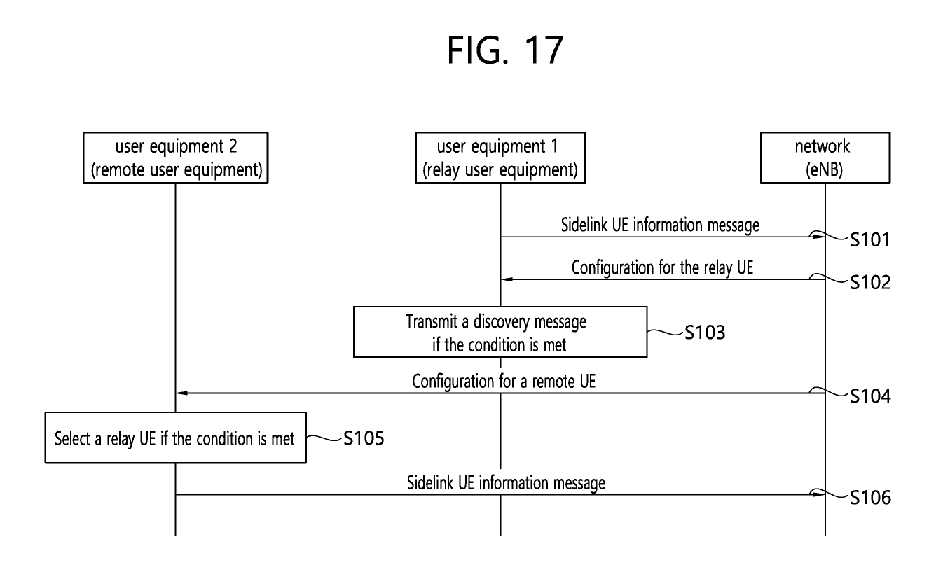

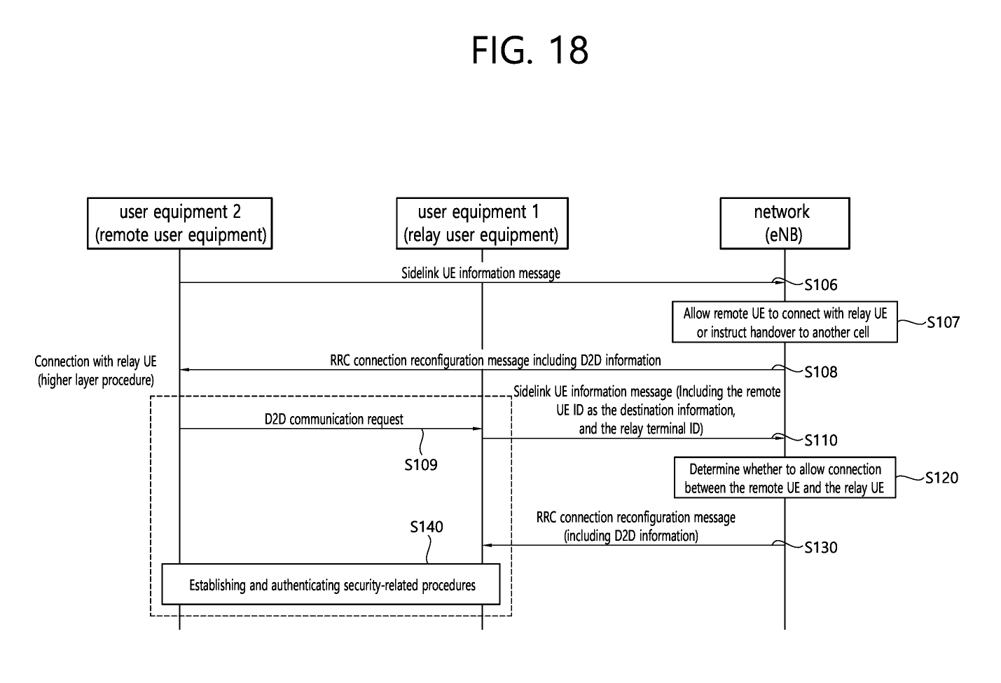

FIG. 17 and FIG. 18 illustrate more specifically the operation method between a relay user equipment and a remote user equipment and a network according to one embodiment of the present invention. After performing the steps described in FIG. 17, steps of FIG. 18 may be performed.

Referring to FIG. 17, a user equipment 1 interested in providing a relay service to another user equipment transmits a sidelink UE information message to its serving cell (S101). This may mean that a user equipment 1 interested in providing a relay service to another user equipment triggers a procedure for transmitting a sidelink UE information message to its serving cell. In this connection, the user equipment 1 includes, in the sidelink UE information message, information such as information for identifying the user equipment 1 in the sidelink communication procedure, that is, an ID of the user equipment 1 which is referred to as L2 ID. Even though the user equipment 1 does not request a transmission resource for signal transmission on the sidelink (e.g., even when the user equipment 1 is only interested in receiving signals on the sidelink), the user equipment 1 may include the user equipment ID in the sidelink UE information message.

Via the user equipment ID (L2 ID), the serving cell receiving the sidelink UE information message may know the user equipment ID in the sidelink relay operation of the user equipment 1. The serving cell may use the user equipment ID to select an optimal relay user equipment upon a relay service request from a remote user equipment (e.g., user equipment 2). For example, when the remote user equipment is in the network's coverage but wants a relay service, the network may select, as a relay device for the remote device, a relay user equipment accessing the same serving cell as the serving cell of the remote user equipment among a plurality of relay user equipments capable of providing a relay service to the remote user equipment.

The user equipment ID is an ID of a user equipment transmitting the sidelink UE information message, and thus may be referred to as a source user equipment ID.

The way the user equipment informs the network that it wants to provide a relay service is as follows: The user equipment may include the source user equipment ID in the sidelink user equipment or the UE information message so that the user equipment may indicate that the sidelink UE information message is for relay service. In a more direct method, the relay user equipment may indicate to the serving cell that it wants to provide a sidelink relay service. For example, the relay user equipment may report to a serving cell a separate indicator indicating the sidelink relay service provision together with its ID. Using a separate indicator to clearly distinguish between a 1:1 D2D communication scenario and a 1:1 D2D relay scenario, it may be preferred that the relay user equipment performs relay service provision. For example, a separate indicator may be added into the sidelink UE information. The indicator may explicitly inform the serving cell of which operation between a 1:1 D2D communication operation and a 1:1 D2D relay operation will be carried out On the other hand, when there is a corresponding user equipment ID in the sidelink user equipment or the UE information message, this may indicate that the sidelink UE information message is for 1:1 D2D communication (for example, 1:1 relay service).

The network provides the user equipment 1 with a relay user equipment configuration (S102). The relay user equipment configuration may indicate when or how a relay operation may be performed. Further, a relay user equipment configuration may specify a condition for a relay user equipment or a candidate relay user equipment to transmit the sidelink UE information for a relay service. The relay user equipment configuration may be broadcast or provided as a dedicated signal to the user equipment 1. Further, the network may also provide the user equipment 1 with a sidelink discovery configuration for use in the sidelink discovery procedure.

The order of the steps S101 and S102 described above may be mutually exchanged.

The user equipment 1 may announce a discovery message indicating that the user equipment 1 may provide a relay service (S103). Alternatively, the user equipment 1 may transmit, to the remote device, a discovery message, which is a response to solicitation from a remote user equipment (for example, user equipment 2).

The sidelink user equipment ID (that is, L2 ID) of the user equipment 1 may be included in the discovery message transmitted by the user equipment 1 or in the discovery response to the solicitation.

In order for the network to indicate when and how a relay service for a remote user equipment, e.g., user equipment 2, is provided, the network provides a remote user equipment configuration to the user equipment 2 (S104). The network may also provide the user equipment 1 with a sidelink discovery configuration used for the relay discovery procedure.

The user equipment 2 detects a candidate relay user equipment, and, then, the user equipment 2 may select a specific user equipment as a relay user equipment according to the reference (S105). The user equipment 2 may select a relay user equipment according to the conditions for the radio environment and criteria in the upper layer. When the remote user equipment is within network coverage, a serving cell accessed by the relay user equipment may be considered when selecting the relay user equipment. For example, a relay user equipment accessing the same serving cell as the serving cell of the remote user equipment may be preferentially selected. To this end, when the relay user equipment announces a discovery message, the relay device may include an identifier of its serving cell in the discovery message. When the remote user equipments may operate simultaneously on multiple frequencies, the remote user equipment may prefer a relay user equipment using a frequency that is different from the frequency of the serving cell thereof. To this end, the relay user equipment may include the serving cell frequency information in the discovery message. The remote user equipment may receive configuration information indicating which relay user equipment should be preferentially selected, from the serving cell in step S104.

When a specific user equipment among candidate relay user equipments is selected as a relay user equipment, the remote user equipment may transmit the sidelink UE information message to the serving cell (S106). The sidelink user equipment or the UE information message transmitted by the remote user equipment may notify the serving cell of the remote user equipment that the remote user equipment itself intends to receive the relay service. Further, the sidelink UE information message may include an ID (L2 ID) on the sidelink of the remote user equipment itself and an ID (L2 ID) of the relay user equipment selected from the candidate relay user equipments.

The serving cell may know the user equipment ID for the sidelink operation of the remote user equipment in the serving cell by using the L2 ID of the remote user equipment included in the sidelink user equipment or the UE information message.

When the network, upon knowing the ID of the relay user equipment, receives a sidelink UE information message including the relay user equipment ID (that is, the L2 ID of the user equipment 1) from the remote user equipment (user equipment 2), the network knows that the sidelink UE information message is for relay service. Generally, when the relay user equipment ID (or source user equipment ID) exists in the sidelink user equipment or the UE information message transmitted by the remote user equipment, this may indicate that the sidelink UE information message is for relay service.

The remote user equipment may inform the serving cell that it wants to receive the sidelink relay service. For example, the remote user equipment may report to its corresponding serving cell a separate indicator indicating the sidelink relay service along with its ID/relay user equipment ID. It may be preferred that the remote user equipment indicates a relay service, using a separate indicator to clearly distinguish between a 1:1 D2D communication scenario and a 1:1 D2D relay scenario.

Referring now to FIG. 18, the network determines whether the relay user equipment corresponding to the relay user equipment ID is allowed to perform a relay service provided to the remote user equipment corresponding to the remote user equipment ID (S107). In this connection, the network may make such determination with considering whether the relay service between the remote user equipment and the relay user equipment in different cells is to be performed, the service requested by the remote user equipment, and the relay service provided by the relay user equipment. If the connection between the remote user equipment and the relay user equipment is not allowed, the remote user equipment may be instructed to handover to another cell, and the remove may be configured to refuse to connect to the corresponding relay user equipment, and, instead, to receive a relay service from another relay user equipment.

When the network decides to provide the user equipment 1 with a relay service by user equipment 2, the D2D configuration for the relay service, or an RRC configuration including the D2D configuration may be provided to the user equipment 2 (S108). For example, the network may include the D2D configuration in the RRC connection reconfiguration message.

The user equipment 2 transmits a message for a 1:1 sidelink communication link establishment request, or a message for a relay link establishment request (D2D communication request message) to the user equipment 1 (S109). In this connection, this transmission may employ the PC5 interface described above.

The sidelink user equipment ID (L2 ID) of the user equipment 2 may be included in the source field for the MAC header of the D2D communication request message.

When the user equipment 1 has received a message for the 1:1 sidelink communication link establishment request or a message for the relay link establishment request (D2D communication request message) from the user equipment 2, the user equipment 1 transmits the sidelink UE information message to the network (S110). In this connection, the sidelink user equipment or the UE information message may be used to notify the serving cell that the user equipment 1 intends to provide a relay service. The message may include a sidelink user equipment ID of the user equipment 1 and a sidelink user equipment ID of the user equipment 2.

The network determines whether to allow a connection between the relay user equipment and the remote user equipment (S120). That is, the network determines whether the user equipment 1 may provide a relay service to the user equipment 2. In this connection, the network may make such determination with considering whether the relay service between the remote user equipment and the relay user equipment in different cells is to be performed, the service requested by the remote user equipment, and the relay service provided by the relay user equipment.

The network provides the D2D configuration (sidelink transmission configuration, sidelink reception configuration) for the relay service to the user equipment 1 (S130). The D2D configuration may be provided using an RRC connection reconfiguration message.

The user equipments 1 and 2 perform establishment of security related procedures and authentication procedures (S140).

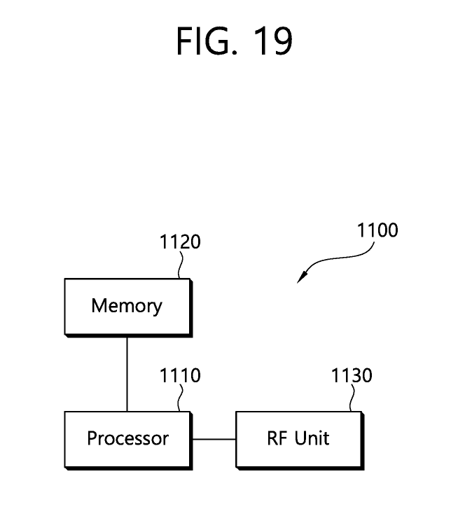

FIG. 19 is a block diagram illustrating a user equipment in which an embodiment of the present invention is implemented.

Referring to FIG. 19, a user equipment 1100 includes a processor 1110, a memory 1120, and a radio frequency unit 1130. The processor 1110 implements the proposed functions, procedures and/or methods. The RF unit 1130 may be coupled to the processor 1110 to receive or transmit a RF signal.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

What is claimed is:

1. A method performed by a user equipment supporting a sidelink in a wireless communication system, the method comprising:
acquiring an identity (ID) of another user equipment to be connected thereto using the sidelink; and
reporting the acquired ID to a network.

2. The method of claim 1, wherein the user equipment is configured to provide a relay service between the another user equipment and the network.

3. The method of claim 1, wherein the user equipment receives a sidelink communication request message from the another user equipment, wherein the sidelink communication request message includes the ID of the another user equipment.

4. The method of claim 1, wherein reporting the acquired ID to the network comprises reporting the acquired ID to the network using sidelink user equipment (UE) information (SidelinkUEInformation) of the user equipment.

5. The method of claim 4, wherein the sidelink user equipment (UE) information further includes an ID of the user equipment.

6. The method of claim 1, further comprising a device-to-device (D2D) configuration from the network, wherein the D2D configuration indicates at least one of a transmission resource used by the user equipment to transmit a sidelink signal to the another user equipment and a reception resource used to receive the sidelink signal from the another user equipment.

7. The method of claim 1, wherein the acquired ID is configured to allow the network to identify the another user equipment in a sidelink operation.

8. The method of claim 1, wherein the user equipment is connected to the another user equipment in a 1:1 manner under the control of the network.

9. The method of claim 1, wherein the another user equipment is in a radio resource control (RRC) idle state.

10. A user equipment comprising:
a RF (radio frequency) unit configured to receive or transmit a RF signal; and
a processor operatively coupled to the RF unit, wherein the processor is configured for:
acquiring an identity (ID) of another user equipment to be connected thereto using the sidelink; and
controlling the RF unit to report the acquired ID to a network.
